(19) United States
(12) Patent Application Publication
(10) Pub. No.: US 2012/0160264 A1
(43) Pub. Date: Jun. 28, 2012

(54) Wet Processing Tool with Site Isolation

(76) Inventor: Richard Endo, San Carlos, CA (US)

(21) Appl. No.: 12/978,177

(22) Filed: Dec. 23, 2010

(51) Int. Cl. B08B 3/12

(52) U.S. Cl. 134/1; 134/184

(57) ABSTRACT

Embodiments of the current invention describe a megasonic processing tool. A substrate support is positioned within a housing and is configured to support a substrate. A first liquid container is moveably coupled to the housing within the testing chamber to be positioned on a first location on the substrate and configured to hold a first body of liquid adjacent to the first location on the substrate. A second liquid container is moveably coupled to the housing within the testing chamber to be positioned on a second location on the substrate and configured to hold a second body of liquid adjacent to the second location on the substrate. The second body of liquid is isolated from the first body of liquid. At least one megasonic transducer is coupled to the housing and configured to perform at least one megasonic process on the first body of liquid and the second body of liquid.

### FIELD OF THE INVENTION

The present invention relates to apparatus and method for performing wet processing on a substrate. More particularly, this invention relates to a megasonic processing tool having site isolation.

### BACKGROUND OF THE INVENTION

Combinatorial processing enables rapid evaluation of semiconductor, solar, or energy processing operations. The systems supporting the combinatorial processing are flexible to accommodate the demands for running the different processes either in parallel, serial or some combination of the two.

Some exemplary processing operations include operations for adding (depositions) and removing layers (etch), defining features, preparing layers (e.g., cleans), doping, etc. Similar processing techniques apply to the manufacture of integrated circuit (IC) semiconductor devices, flat panel displays, optoelectronics devices, data storage devices, magneto electronic devices, magneto optic devices, packaged devices, and the like. As feature sizes continue to shrink, improvements, whether in materials, unit processes, or process sequences, are continually being sought for the deposition processes. However, semiconductor and solar companies conduct research and development (R&D) on full wafer processing through the use of split lots, as the conventional deposition systems are designed to support this processing scheme. This approach has resulted in ever escalating R&D costs and the inability to conduct extensive experimentation in a timely and cost effective manner. Combinatorial processing as applied to semiconductor, solar, or energy manufacturing operations enables multiple experiments to be performed at one time in a high throughput manner. Equipment for performing the combinatorial processing and characterization must support the efficiency offered through the combinatorial processing operations.

### BRIEF DESCRIPTION OF THE DRAWINGS

Various embodiments of the invention are disclosed in the following detailed description and the accompanying drawings:

FIG. 1 is a simplified cross-sectional schematic view of a wet processing system according to one embodiment of the present invention;

FIGS. 2 and 3 are isometric views of an interior of a processing chamber of the system of FIG. 1;

FIG. 4 is an isometric view of a row of wet processing units within the system of FIG. 1;

FIG. 5 is a simplified cross-section schematic of a portion of one of the wet processing units of FIG. 4 positioned on a substrate;

FIG. 6 is a plan view of the substrate of FIG. 5 indicating regions on the substrate surrounded by the wet processing units of FIG. 4; and

FIGS. 7 and 8 are plan views of substrates indicating regions surrounded by wet processing units according to other embodiments of the present invention.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

The embodiments described below provide details for a multi-region processing system and associated processing heads that enable processing a substrate in a combinatorial fashion. Thus, different regions of the substrate may have different properties, which may be due to variations of the materials, unit processes (e.g., processing conditions or parameters) and process sequences, etc. Within each region the conditions are preferably substantially uniform so as to mimic conventional full wafer processing within each region, however, valid results can be obtained for certain experiments without this requirement. In one embodiment, the different regions are isolated so that there is no inter-diffusion between the different regions.

In addition, the combinatorial processing of the substrate may be combined with conventional processing techniques where substantially the entire substrate is uniformly processed (e.g., subjected to the same materials, unit processes and process sequences). Thus, the embodiments described herein can pull a substrate from a manufacturing process flow, perform combinatorial deposition processing and return the substrate to the manufacturing process flow for further processing. Alternatively, the substrate can be processed in an integrated tool that allows both combinatorial and conventional processing in a single chamber or various chambers attached around a central chamber. Consequently, in one substrate, information concerning the varied processes and the interaction of the varied processes with conventional processes can be evaluated. Accordingly, a multitude of data is available from a single substrate for a desired process.

The embodiments described herein enable the application of combinatorial techniques to process sequence integration in order to arrive at a globally optimal sequence of semiconductor manufacturing operations by considering interaction effects between the unit manufacturing operations, the process conditions used to effect such unit manufacturing operations, as well as materials characteristics of components utilized within the unit manufacturing operations. Rather than only considering a series of local optimums, i.e., where the best conditions and materials for each manufacturing unit operation is considered in isolation, the embodiments described below consider interactions effects introduced due to the multitude of processing operations that are performed and the order in which such multitude of processing operations are performed when fabricating a semiconductor device. A global optimum sequence order is therefore derived and as part of this derivation. The unit processes, unit process parameters, and materials used in the unit process operations of the optimum sequence order are also considered.

The embodiments described further below analyze a portion or sub-set of the overall process sequence used to manufacture a semiconductor device. Once the subset of the process sequence is identified for analysis, combinatorial process sequence integration testing is performed to optimize the materials, unit processes and process sequence used to build that portion of the device or structure. During the processing of some embodiments described herein, structures are formed on the processed semiconductor substrate equivalent to the structures formed during actual production of the semiconductor device. For example, such structures may include, but would not be limited to, trenches, vias, interconnect lines, capping layers, masking layers, diodes, memory elements, gate stacks, transistors, or any other series of layers or unit processes that create an intermediate structure found on semiconductor chips. While the combinatorial processing varies certain materials, unit processes, or process sequences, the composition or thickness of the layers or structures or the action of the unit process, such as cleaning, surface preparation, etch, deposition, planarization, implantation, surface treatment, etc. is substantially uniform through each discrete region. Furthermore, while different materials or unit processes may be used for corresponding layers or steps in the formation of a structure in different regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a thickness of a layer is varied or a material may be varied between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameter (e.g., materials, unit processes, unit process parameters, or process sequences) and not the lack of process uniformity.

According to one aspect of the present invention, a megasonic processing tool is provided, which allows the megasonic process(es) to be varied across a substrate being processed. The processing tool includes a housing enclosing a testing chamber, and a substrate support coupled to the housing and positioned within the testing chamber. A first liquid container is moveably coupled to the housing within the testing chamber to be positioned on a first location on a substrate on the substrate support. The first liquid container is configured to hold a first body of liquid adjacent to the first location on the substrate. A second liquid container is moveably coupled to the housing within the testing chamber to be positioned on a second location on the substrate and configured to hold a second body of liquid adjacent to the second location on the substrate. The second body of liquid is isolated from the first body of liquid. The processing tool also includes one or more megasonic transducers coupled to the housing and configured to perform at least one megasonic process on the first body of liquid and the second body of liquid.

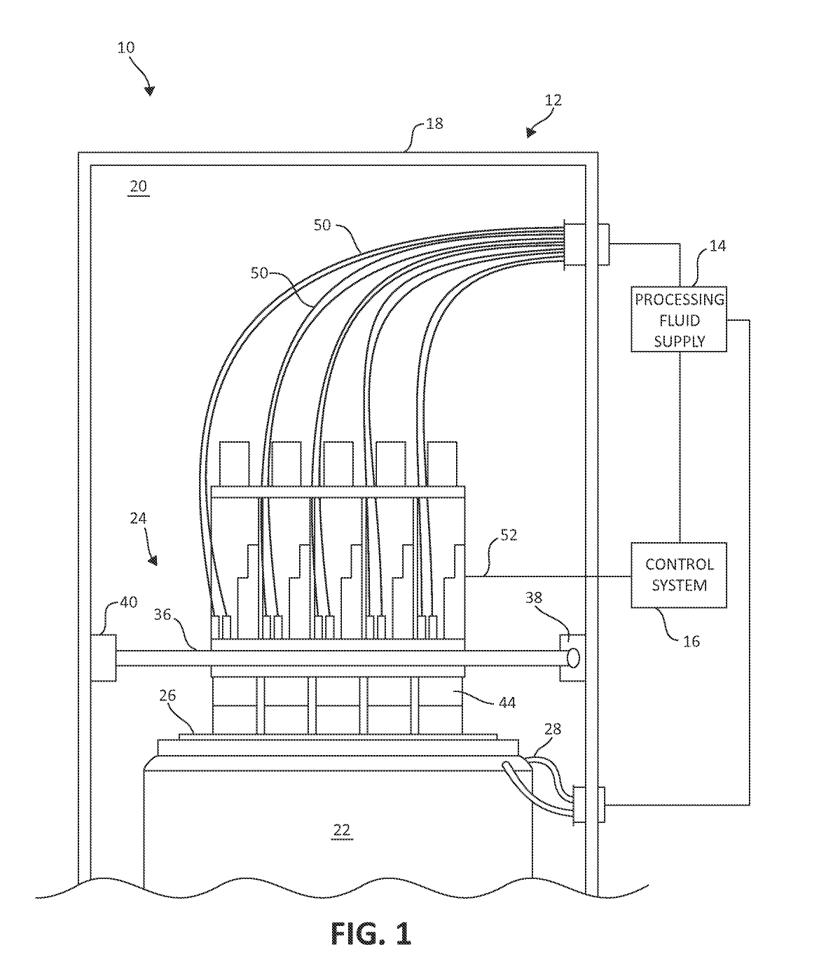

FIG. 1 illustrates a wet (or megasonic) processing system 10, according to one embodiment of the present invention. The wet processing system 10 includes a wet processing tool (and/or apparatus) 12, a processing fluid supply system 14, and a control system 16.

The wet processing tool 12 includes a housing 18 enclosing a processing chamber 20, a substrate support 22, and a wet processing assembly 24. Referring now to FIGS. 1, 2, and 3, the substrate support 22 is positioned within the processing chamber 20 and is configured to hold a substrate 26. Although not shown in detail, the substrate support 22 may be configured to secure the substrate using, for example, a vacuum chuck, electrostatic chuck, or other known mechanism. Additionally, the substrate support 22 may have a series of fluid passageways extending therethrough which are in fluid communication with the processing fluid supply system 14 via support fluid lines 28.

The substrate 26 may be a conventional, round substrate (or wafer) having a diameter of, for example, 200 millimeter (mm) or 300 mm. In other embodiments, the substrate 26 may have other shapes, such as a square or rectangular. It should be understood that the substrate 126 may be a blanket substrate (i.e., having a substantial uniform surface), a coupon (e.g., partial wafer), or even a patterned substrate having predefined regions (or locations) 30. The term region is used herein to refer to a localized area on a substrate which is, was, or is intended to be used for processing or formation of a selected material. The region may include one region and/or a series of regular or periodic regions pre-formed on the substrate. The region may have any convenient shape, e.g., circular, rectangular, elliptical, wedge-shaped, etc. In the semiconductor field a region may be, for example, a test structure, single die, multiple die, portion of a die, other defined portion of substrate, or a undefined area of a, e.g., blanket substrate which is defined through the processing.

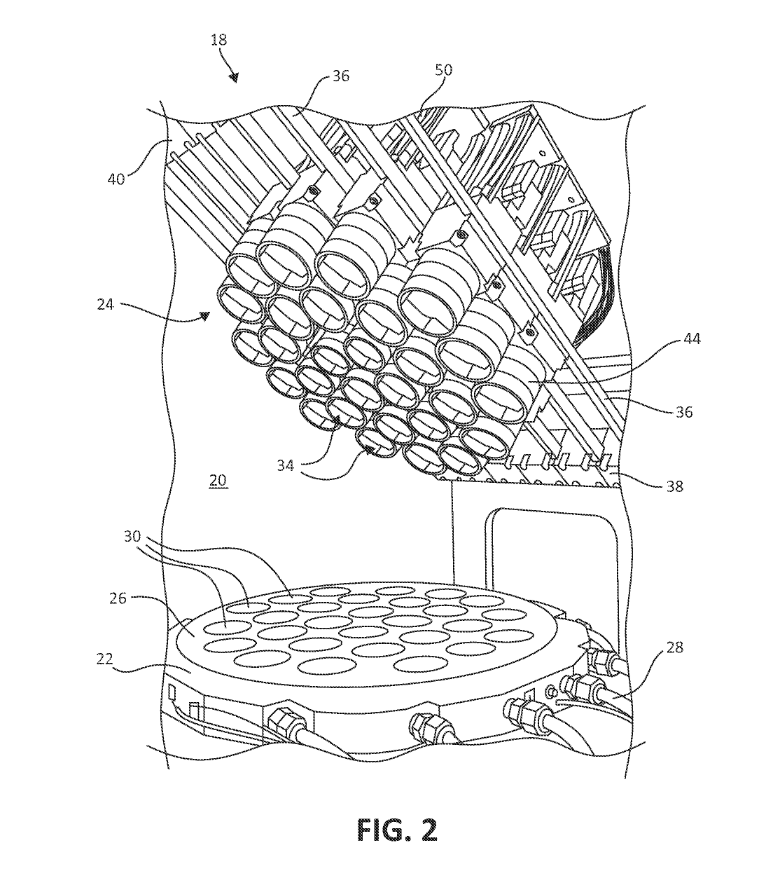

Still referring to FIGS. 1, 2, and 3, the wet processing assembly 24 includes a scaffolding 32 and an array of wet processing units 34 attached to the scaffolding 34. The scaffolding 32 includes a plurality of scaffolding bars 36 extending between end pieces 38 and 40. As shown in FIG. 2, end piece 38 is pivotably (or rotatably) coupled to the housing 18.

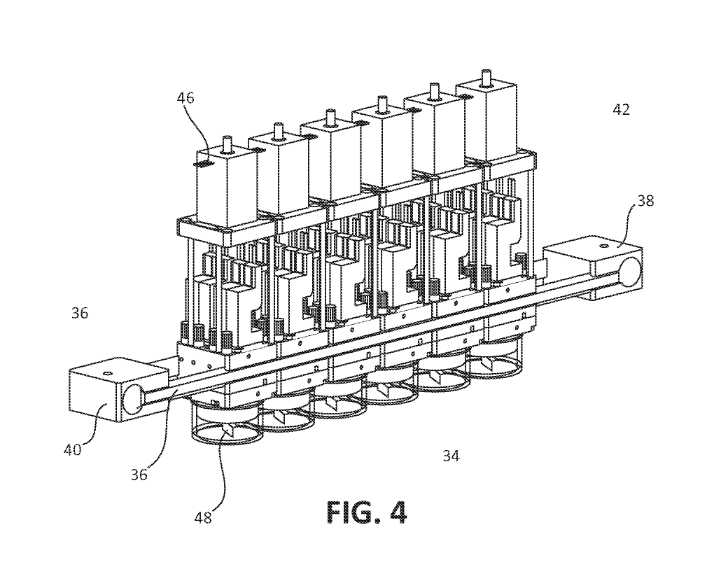

The wet processing units 34 are arranged in a series of rows (or sticks) 42, with each of the rows 42 being positioned between adjacent scaffolding bars 36. FIG. 4 illustrates one of the rows 42 of wet processing units 34. The row 42 shown in FIG. 4 includes six of the wet processing units 34. However, as shown in FIGS. 1, 2, and 3, the number of wet processing units 34 in each row 42 may differ, as is appropriate given the size and shape of the substrate 26. Each of the wet processing units 34 includes, amongst other components, a liquid container (or reactor) 44, a transducer actuator 46 housed above the liquid container 44, and a transducer (i.e., megasonic transducer) 48 positioned within the liquid container 44 and coupled to the transducer actuator 46.

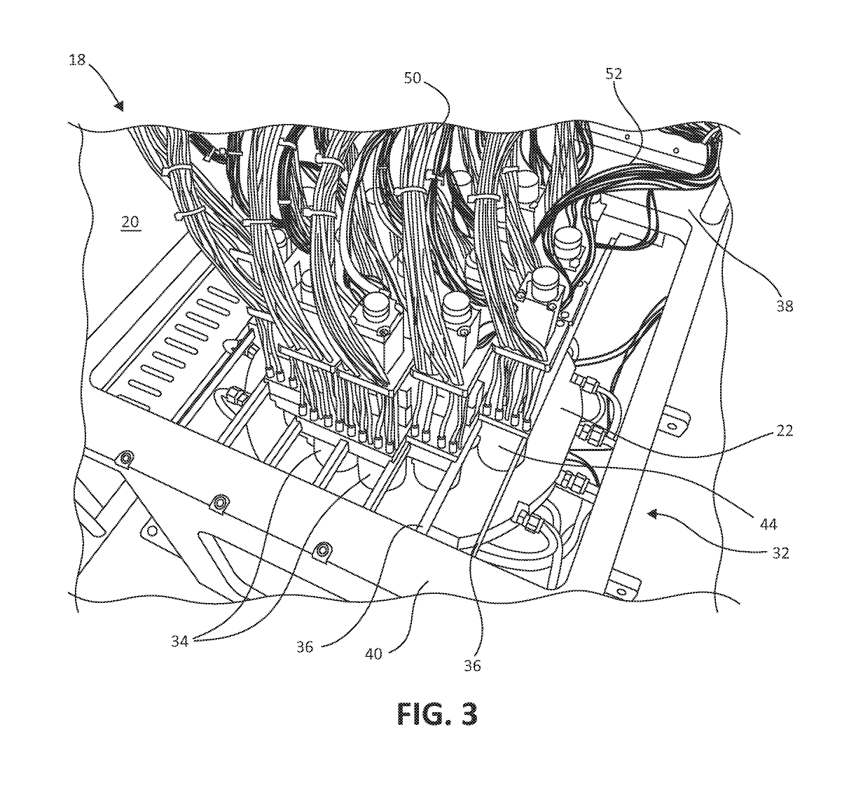

Referring again to FIGS. 1, 2, and 3, each of the liquid containers 44 is in fluid communication with the processing fluid supply system 14 via a series of fluid lines 50. Further, each of the wet processing units 34 (and/or the transducer actuators 46) is in operable communication with the control system 16 via wiring 52 (FIGS. 1 and 3).

The processing fluid supply system 14 includes one or more supplies of various processing fluids, such as cleaning solutions, as well as temperature control units to regulate the temperatures of the various fluids. The control system 16 includes, for example, a processor and memory (i.e., a computing system) in operable communication with the processing fluid supply system 14 and the wet processing units 34 and is configured to control the operation thereof as described below.

Referring again to FIGS. 1 and 2, after the substrate 26 is positioned on the substrate support 22 (i.e., by a robot which is not shown), the wet processing assembly 24 is lowered (or pivoted downwards) such that the liquid containers 44 of the wet processing units 34 contact the substrate 26 (or a surface thereof).

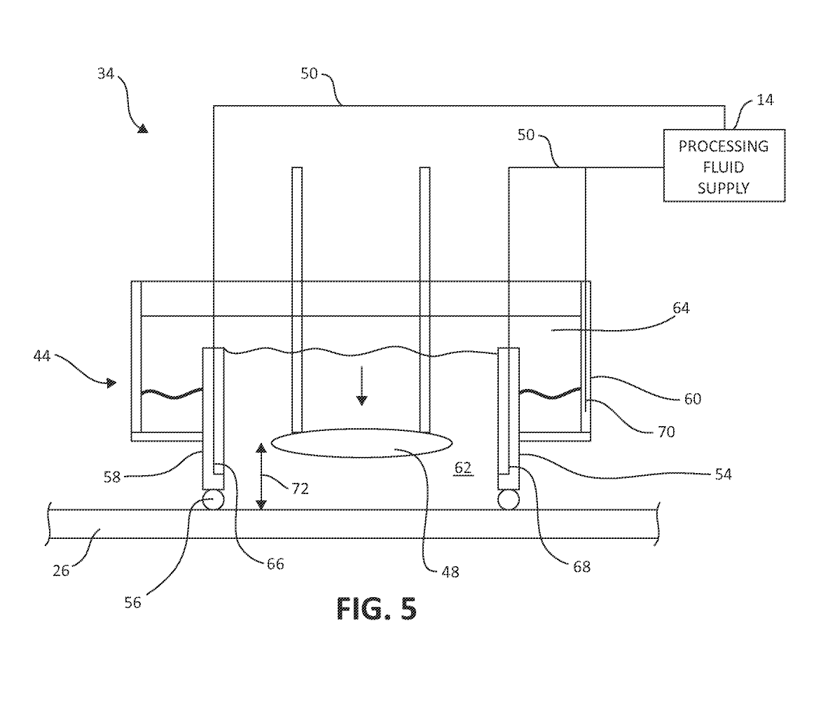

FIG. 5 schematically illustrates one of the wet processing units 34 (and/or one of the liquid containers 44) in contact with the substrate 26. The liquid container 44 further includes a liquid container body 54 and a sealing member 56.

The liquid container body 54 includes a main portion 58 and an overflow portion 60. The main portion 58 of the liquid container body 54 houses the transducer 48 and encloses a reactor region 62 which is in contact with the substrate 26. The overflow portions 60 enclose an overflow region 64 which surrounds the reactor region 62 and is not in contact with the substrate 26. The liquid container body 54 further includes an inlet port 66 in fluid communication with the reactor region 62 and the processing fluid supply system 14 (via fluid lines 50), and outlet ports 68 and 70 in fluid communication with the reactor region 62 and the overflow region 64, respectively, as well as the processing fluid supply system 14 (via fluid lines 50). As shown, the transducer 48 is suspended a distance 72 above the substrate 26. As described below, in one embodiment, the distance 72 may be varied (e.g., between 1 mm and 50 mm), which effects the potency of the cleaning effect (i.e., a second order effect).

The sealing member 56 is positioned between the main portion 58 of the liquid container body 54 and the substrate 26. The sealing member 26 may take the form of an o-ring or lip seal and may be made of a compressible material, such as rubber, such that when a force (i.e., the weight of the wet processing assembly 24) is applied onto it towards the substrate 26, a seal is formed between the liquid container body 54 and the substrate 26.

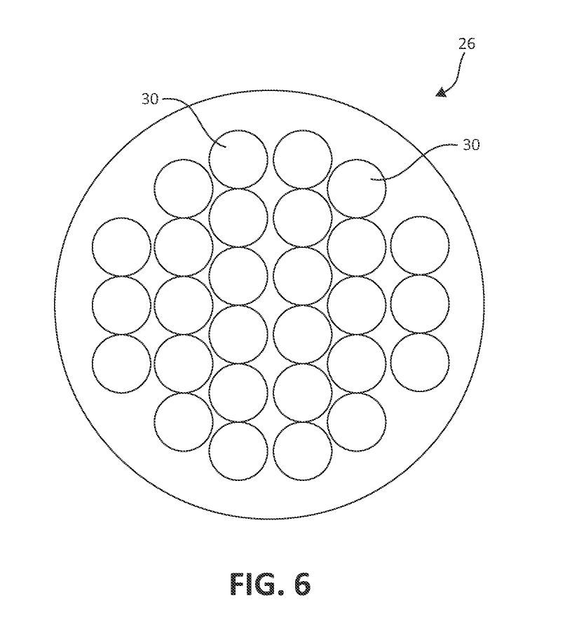

Referring now to FIG. 6 in combination with FIG. 5, each of the sealing members 56 may surround one of the regions 30 on the substrate 26 such that each of the reactor regions 62 within the liquid containers 44 is adjacent to a respective one of the regions 30.

The system 10 may then perform any of numerous wet processing methods on the regions 30 of the substrate 26. Examples of wet processes include wet cleanings, wet etches and/or strips, and electroless depositions. Referring to FIG. 5, these methods may generally be performed by providing various processing fluids (i.e., liquids, gases, or a combination thereof) to the reactor regions 62 of the wet processing units 34 from the processing fluid supply system 34 and operating the transducers 48 (and/or the transducer actuators 46). In one embodiment, the transducers 48 are repeatedly actuated in a direction 74 that is substantially parallel to the surface of the substrate 26 at frequencies of, for example, between 40 and 2000 kHz (i.e., megasonic frequencies). The overflow regions 64 of the liquid containers 44 are used to capture excess fluid (i.e., before flowing onto the substrate 26) while maintaining a relative constant volume of fluid in the reactor region 62). During or after the processing, the processing fluids are removed from the reactor regions 62 and the overflow regions 64 through the outlet ports 68 and 70.

Of particular interest is that because of the sealing action of the sealing members 56, along with the multiple, individual liquid containers 44, separate and unique wet processes may be performed simultaneously on the different regions 30 (FIG. 6) of the substrate, as the volume (or body) of liquid (and/or gas) held in each liquid container 44 is isolated from the others. The portions of the substrate 26 between the regions 30 remain dry.

According to one aspect of the present invention, the wet processing system 10 is provided with a variation generating system (or subsystem) configured to intentionally vary (or create differences between) the wet processes performed on two or more of the regions 30. The variation generating system may include, for example, the processing fluid supply system 14, the transducers 46 (and/or the transducer actuators 46), and/or the control system 16.

One possible variation generated between two or more of the processes is the chemical composition, pH level, and/or temperatures of the processing fluids, as well as any processing gases dissolved therein, provided to the liquid containers 44 by the processing fluid supply system 14.

One possible type of processing fluid that may be used is cleaning liquids. An example of a cleaning liquid is a mixture of ammonium hydroxide (NH₄OH), hydrogen peroxide (H₂O₂), and deionized (DI) water (H₂O). A typical concentration ratio for the mix is 1:1:5 NH₄OH:H₂O₂:H₂O. However, as described herein, this ratio may be varied among the different liquid containers 44. Such a mixture may perform well at removing particles, as well as organic and metallic contaminants, from the surface of the substrate 26. Another example of a cleaning liquid is a mixture of hydrochloric acid (HCl), hydrogen peroxide (H₂O₂), and deionized (DI) water (H₂O). A typical concentration ratio for the mix is 1:1:5 HCl:H2O2:H2O. Again, however, this ratio may be varied among the different liquid containers 44 is accordance with one aspect of the present invention. Such a mixture may be used for removing metal contaminants from the surface of the substrate 26.

It should be understood that the surface of the substrate 26 being processed may take the form of any semiconductor process surface, either at the front end of the line (FEOL) or the back end of the line (BEOL), as is commonly understood. Examples include BEOL low-k dielectrics on logic dies, any surface after a chemical-mechanical polishing (CMP), and high-k dielectrics on memory dies. Examples of cleanings include FEOL pre-gate cleanings and BEOL post-copper etch cleanings.

Another possible variation is related to the operation of the transducers 48. For example, the frequencies at which the transducers 48 are actuated (e.g., between 40 and 2000 KHz), the power provided to (i.e., the amplitude of actuation of) the transducer actuators 46 (e.g., between 0.1-2.0 W/sq. cm² as measured on the substrate 26), the direction 74 of actuation of the transducers 48 (e.g., between perpendicular to the substrate 26 and 45 degrees), and/or the distance 72 between the transducers 48 and the substrate 26 (e.g., 1 mm-50 mm) may be varied. As another example, the duration of the actuation of the transducers 48 may be varied such that some regions 30 of the substrate 26 (and/or corresponding liquid) experience a megasonic process for a longer or shorter period of time compared to the other regions 30.

In one embodiment, the direction 74 of actuation of the transducers 48 and the distance 72 between the transducers 48 and the substrate 26 may not be controlled by the control system 16 per se. Rather, the direction 74 of actuation of the transducers 48 and the distance 72 between the transducers 48 and the substrate 26 may be adjusted by a technician during servicing and/or be built-in characteristics of the individual wet processing units 34.

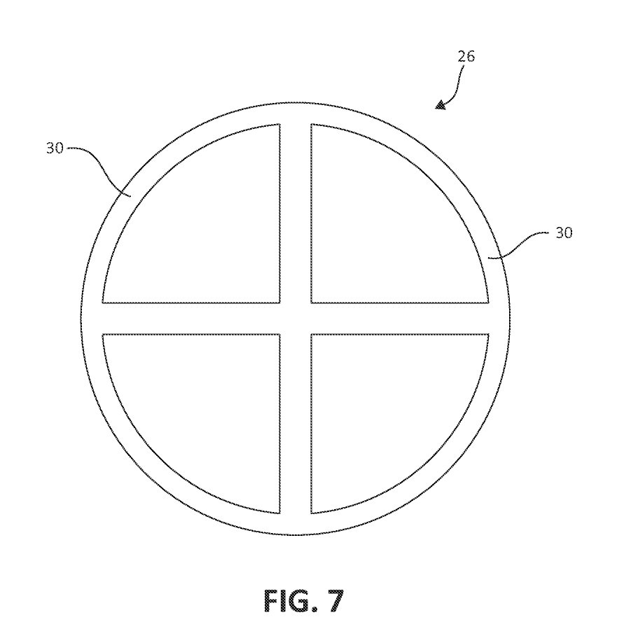

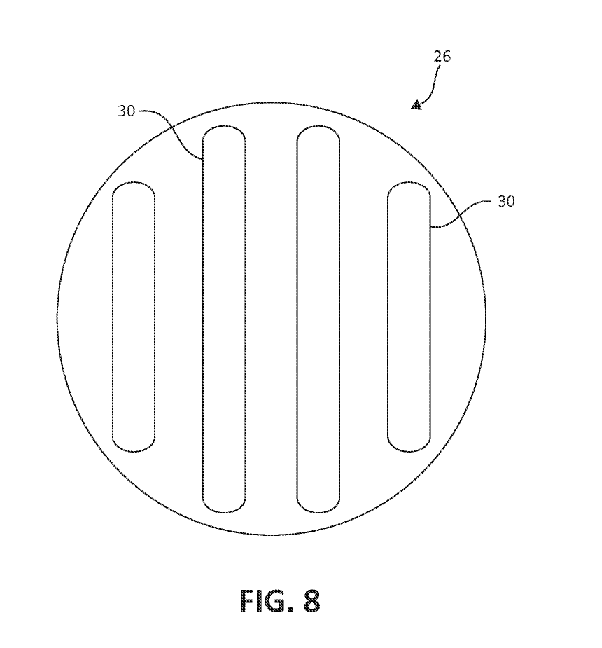

It should be understood that the size, shape, and number of the liquid containers 44 and/or the corresponding regions 30 on the substrate 26 may be different in other embodiments. FIGS. 7 and 8 illustrate the regions 30 on the substrate 26 surrounded by the liquid containers 44 in other embodiments of the present invention. In FIG. 7, the substrate 26 includes four regions 30, each of which essentially occupies a quadrant on the substrate 26. In FIG. 8, the regions 30 are in the shape of parallel strips extending across the substrate 26. Although not shown, it should be understood that the liquid containers 44 corresponding to such embodiments may be sized and shaped in such a way to as to seal the regions shown and may each include one or more transducers.

In one embodiment, a megasonic processing tool is provided. The megasonic processing tool includes a housing enclosing a testing chamber, a substrate support coupled to the housing and positioned within the testing chamber, the substrate support being configured to support a substrate, a first liquid container moveably coupled to the housing within the testing chamber to be positioned on a first location on the substrate and configured to hold a first body of liquid adjacent to the first location on the substrate, a second liquid container moveably coupled to the housing within the testing chamber to be positioned on a second location on the substrate and configured to hold a second body of liquid adjacent to the second location on the substrate such that the second body of liquid is isolated from the first body of liquid, and at least one megasonic transducer coupled to the housing and configured to perform at least one megasonic process on the first body of liquid and the second body of liquid.

In another embodiment, a megasonic processing tool is provided. The megasonic processing tool includes a housing enclosing a testing chamber, a substrate support coupled to the housing and positioned within the testing chamber, the substrate support being configured to support a substrate, a plurality of liquid containers moveably coupled to the housing within the testing chamber to be positioned onto a respective plurality of locations on the substrate, each of the plurality of liquid containers being configured to hold a respective one of a plurality of bodies of liquid such that each of the plurality of bodies of liquid are isolated from the others of the plurality of bodies of liquid, a plurality of megasonic transducers, each of the plurality of megasonic transducers being coupled to a respective one of the plurality of liquid containers and configured to perform a megasonic process on the respective one of the plurality of bodies of liquid, and a variation generating system coupled to the housing and configured to generate a variation between the at least two of the megasonic processes.

In a further embodiment, a method for processing a substrate is provided. A first body of liquid in contact with a first portion of the substrate is provided. A second body of liquid in contact with a second portion of the substrate is provided. The second body of liquid being isolated from the first body of liquid. A first megasonic process is performed on the first body of liquid. A second megasonic process is performed on the second body of liquid.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A megasonic processing tool comprising:
a housing enclosing a testing chamber;
a substrate support coupled to the housing and positioned within the testing chamber, the substrate support being configured to support a substrate;
a first liquid container moveably coupled to the housing within the testing chamber to be positioned on a first location on the substrate and configured to hold a first body of liquid adjacent to the first location on the substrate;
a second liquid container moveably coupled to the housing within the testing chamber to be positioned on a second location on the substrate and configured to hold a second body of liquid adjacent to the second location on the substrate such that the second body of liquid is isolated from the first body of liquid; and
at least one megasonic transducer coupled to the housing and configured to perform at least one megasonic process on the first body of liquid and the second body of liquid.

2. The megasonic processing tool of claim 1, wherein the at least one megasonic transducer comprises:
a first megasonic transducer configured to perform a first megasonic process on the first body of liquid; and
a second megasonic transducer configured to perform a second megasonic process on the second body of liquid.

3. The megasonic processing tool of claim 2, further comprising a variation generating system coupled to the housing and configured to generate a variation between the first megasonic process and the second megasonic process.

4. The megasonic processing tool of claim 3, wherein the variation generating system is configured to vary power levels of the first and second megasonic transducers, frequencies of operation of the first and second megasonic transducers, duration of the operation of the first and second megasonic transducers, or a combination thereof.

5. The megasonic processing tool of claim 3, wherein the variation generating system is configured to vary a direction of actuation of the first and second megasonic transducers.

6. The megasonic processing tool of claim 3, wherein the variation generating system is configured to vary temperatures of the first and second bodies of liquid.

7. The megasonic processing tool of claim 3, further comprising a plurality of fluid reservoirs in fluid communication with the first liquid container and the second liquid container, each of the plurality of fluid reservoirs being configured to hold a respective one of a plurality of processing fluids, and wherein the variation generating system is configured to:
control the flow of plurality of processing fluids from the plurality of fluid reservoirs into the first liquid container and the second liquid container; and
vary chemical compositions of the first and second bodies of liquid, pH levels of the first and second bodies of liquid, or a combination thereof.

8. The megasonic processing tool of claim 7, wherein the plurality of processing fluids comprises a plurality of processing liquids and a plurality of dissolved processing gases.

9. The megasonic processing tool of claim 3, wherein the variation generating system is configured to vary respective distances between the first and second megasonic transducers and the substrate.

10. The megasonic processing tool of claim 1, wherein the first liquid container comprises a first container body and a first sealing member, the first sealing member being positioned between the substrate and the first container body such that substantially none of the first body of liquid flows between the substrate and the first container body when the first liquid container is positioned on the first location of the substrate, and the second liquid container comprises a second container body and a second sealing member, the second sealing member being positioned between the substrate and the second container body such that substantially none of the second body of liquid flows between the substrate and the second container body when the second liquid container is positioned on the second location of the substrate.

11. A megasonic processing tool comprising:
a housing enclosing a testing chamber;
a substrate support coupled to the housing and positioned within the testing chamber, the substrate support being configured to support a substrate;
a plurality of liquid containers moveably coupled to the housing within the testing chamber to be positioned onto a respective plurality of locations on the substrate, each of the plurality of liquid containers being configured to hold a respective one of a plurality of bodies of liquid such that each of the plurality of bodies of liquid are isolated from the others of the plurality of bodies of liquid;
a plurality of megasonic transducers, each of the plurality of megasonic transducers being coupled to a respective one of the plurality of liquid containers and configured to perform a megasonic process on the respective one of the plurality of bodies of liquid; and
a variation generating system coupled to the housing and configured to generate a variation between the at least two of the megasonic processes.

12. The megasonic processing tool of claim 11, wherein each of the plurality of liquid containers comprises a container body and a sealing member, the sealing member being positioned between the substrate and the container body such that substantially none of the respective body of liquid flows between the substrate and the container body when the respective liquid container is positioned on the respective location of the substrate.

13. The megasonic processing tool of claim 11, wherein the variation generating system is configured to vary power levels of the plurality of megasonic transducers, frequencies of operation of the plurality of megasonic transducers, directions of actuation of the plurality of megasonic transducers, or a combination thereof.

14. The megasonic processing tool of claim 11, wherein the variation generating system is configured to vary temperatures of the plurality of bodies of liquid.

15. The megasonic processing tool of claim 11, further comprising a plurality of fluid reservoirs in fluid communication with the plurality of liquid containers, each of the plurality of fluid reservoirs being configured to hold a respective one of a plurality of processing fluids, the plurality of processing fluids comprising a plurality of processing liquids and a plurality of processing gases, and wherein the variation generating system is configured to:
control the flow of the plurality of processing fluids from the plurality of fluid reservoirs into the plurality of liquid containers; and
vary chemical compositions of the plurality of bodies of liquid, pH levels of the plurality of liquid, or a combination thereof.

16. A method for processing a substrate comprising:
providing a first body of liquid in contact with a first portion of the substrate;
providing a second body of liquid in contact with a second portion of the substrate, the second body of liquid being isolated from the first body of liquid;
performing a first megasonic process on the first body of liquid; and
performing a second megasonic process on the second body of liquid.

17. The method of claim 16, further comprising generating a variation between the first megasonic process and the second megasonic process.

18. The method of claim 17, wherein the first and second megasonic processes are performed with respective first and second transducers, the first transducer being in contact with the first body of liquid and the second transducer being in contact with the second body of liquid, and wherein the generating of the variation between the first megasonic process and the second megasonic process comprises adjusting power levels of the first and second transducers, frequencies of operation of the first and second transducers, directions of actuation of the first transducer and the second transducer, distances between the first and second transducers and the substrate, or a combination thereof.

19. The method of claim 17, wherein the generating of the variation between the first megasonic process and the second megasonic process comprises adjusting temperatures of the first and second bodies of liquid.

20. The method of claim 17, wherein the generating of the variation between the first megasonic process and the second megasonic process comprises adjusting chemical compositions of the first and second bodies of liquid, pH levels of the first and second bodies of liquid, or a combination thereof.
